(19) United States
(12) Patent Application Publication
(10) Pub. No.: US 2024/0334946 A1
(43) Pub. Date: Oct. 10, 2024

(54) BUTTER PRODUCTS AND SYSTEMS AND METHODS FOR MAKING BUTTER PRODUCTS

(71) Applicants: Gary Alan Steinhauer, Jr., Verona, WI (US); Randall Lee Steinhauer, Verona, WI (US)

(72) Inventors: Gary Alan Steinhauer, Jr., Verona, WI (US); Randall Lee Steinhauer, Verona, WI (US)

(21) Appl. No.: 18/624,717

(22) Filed: Apr. 2, 2024

Related U.S. Application Data
(60) Provisional application No. 63/494,196, filed on Apr. 4, 2023.

(51) Int. Cl. A23C 15/12; A23L 5/43

(52) U.S. Cl. CPC A23C 15/12; A23L 5/43

(57) ABSTRACT

The disclosure relates to a dairy product. In one embodiment, the disclosure relates to a butter product. In one embodiment, the disclosure relates to a butter product comprising a first butter having a first color and a second butter having a second color. In one embodiment, the disclosure relates to a butter having a marbled appearance.

### CROSS REFERENCE TO RELATED APPLICATIONS

This application claims priority to and is a non-provisional patent application of U.S. Patent Application No. 63/494,196 filed Apr. 4, 2023, which is incorporated herein by reference in its entirety.

### FIELD

The disclosure relates to a dairy product. In one embodiment, the dairy product is a butter or a butter product. In one embodiment, the disclosure relates to a butter or a butter product comprising a first butter having a first color and a second butter having a second color. In one embodiment, the disclosure relates to a butter having a marbled appearance with areas of a first color and areas of a second color.

### BACKGROUND

Butter preparation methods represent some of the oldest techniques for preserving fat components that are found in milk. Butter manufacture has been accomplished in one form or another for over 4500 years. Over the centuries, butter has been used for medicinal and cosmetic purposes, and as a human food.

Butter production techniques generally evolved into more sophisticated techniques as new forms and uses of equipment developed. For example, the barrel churn made its appearance toward the end of the 18th century when non-wooden manufacturing materials entered widespread use in creaming and butter-making equipment. These advances led to improvements in cream separation techniques and, by 1879, continuous operation cream separators were known in parts of Europe. Likewise, butter production evolved from an individual farm activity to a factory-based technique with the introduction of milk pooling systems for creamery operation in the 1870s. Later advances in fat quantification techniques, pasteurization, refrigeration, and bacterial culture usage further advanced the art of butter production.

Butter is typically a minimum 80% fat, all butterfat, product. Butter is a water-in-oil emulsion made by an inversion process from cream, which is an oil-in-water emulsion. Butter remains a solid when refrigerated but softens to a spreadable consistency after equilibration to room temperature. A stick of butter, for example, removed from a refrigerator can take about 30 to 45 minutes to equilibrate to room temperature. In fact, consumer practice is to leave the butter out for up to 2-hrs to soften it and use it for various applications. Butter melts to a thin liquid consistency at about 32-35° C. (90-95° F.).

Advances in butter production technology helped make butter a staple item in the kitchen. Certain components of butter, such as interfacial butter solids, give butter-based baked goods properties that are not achievable by margarines and presently available butter/margarine blends. For example, butter melts somewhat evenly in the mouth to yield a smooth, rich mouth-feel that is characteristic of butter. As another example, the protein and lactose components of butter give desirable browning characteristics to baked goods that incorporate butter. Also, the phospholipid portion of butter gives body to baked goods and gives the baked goods the characteristic rich flavor long associated with butter. Phospholipids, proteins, and sugars, such as lactose, are each components of interfacial butter solids.

Despite these highly desirable taste and baking properties associated with butter, butter consumption came under attack by nutritionists and the medical profession during the 1970s and 1980s because of links thought to exist between butter consumption and certain health conditions. Also, butter prices tend to be relatively volatile over the long term.

These factors led to increasing use of butter substitutes, such as margarine and butter/margarine blends, which included fat sources in addition to, or other than, butterfat. Existing butter/margarine blends, which are often referred to as “spreadable butters,” are typically based on butter; other fat sources, such as soybean oil, cotton seed oil, canola oil, and other types of vegetable oils; water; and emulsifying agents, such as monoglycerides and diglycerides. Margarines are typically based on various combinations of water and vegetable oils and may include or exclude butterfat, depending upon the formulation of the particular margarine.

These “spreadable butters” remain softer at colder temperatures and are therefore easier to use directly from refrigeration. In certain cases, the “spreadable butters” are made by modifying the makeup of the butter's fat composition through chemical manipulation of the finished product. In other cases, vegetable oils are incorporated into the butter to obtain the softer characteristics. These, however, do not always have the desired performance attributes or taste characteristics compared to traditional butter. Butter products are also produced with altered characteristics by manipulating the cattle's feed, but this has the drawback of being an expensive undertaking that has limited commercial use. Whipped butter has also been made that is more spreadable and is made through incorporation of nitrogen gas. A drawback to the use of air for whipping is that faster oxidation can occur, which leads to the development of rancidity in the butter.

However, even present margarines that include butterfat and present butter/margarine blends that include butter do not have the characteristic mouth-feel of butter and typically do not give baked goods the browning properties and body-yielding properties that are characteristic of butter. This is true even though numerous artificial butter flavoring compounds have been developed and incorporated into margarines and butter/margarine blends over the years.

If one is committed to real butter, one can select between a butter that is yellow in color or a butter that has a white or whitish appearance. The most significant difference between a butter that is yellow in color and a butter that is whitish in color is the amount of beta-carotene levels that are present. Cows that are grass-fed will typically have higher beta-carotene levels and will therefore produce a more yellow butter. Cows that are grain-fed will have lower beta-carotene levels and will therefore produce a butter that is whitish in color. Not all cows are strictly fed grass or grain, resulting in an array of butter color variations ranging from deep dark yellow to white, which are dependent on the feed ratios and subsequent beta-carotene levels.

One major difference between market sold butter that is yellow in color and butter that is whitish in color is the nutrient value. Natural yellow butter contains beta-carotene, an antioxidant, as well as vitamins, Omega 3 fatty acids and healthy enzymes, meaning it is generally regarded as healthier than butter that is whitish in color. Nevertheless, butter that is whitish is still considered a good source of calcium and vitamins and is more widely preferred by consumers in the United States. Butter/margarine blends that are processed may appear yellow, but typically contain excess salt, trans fats, sugars, coloring agents and lack the health benefits natural yellow butter provides.

There are advantages to both a butter that is yellow in color and a butter that is whitish in color. As such, provided herein are butter products, systems and methods for making butter products and other dairy-based products from butter that is yellow in color and butter that is whitish in color.

### SUMMARY

In one embodiment, the disclosure provides a dairy product. In one embodiment, the disclosure relates to a dairy product comprising two or more butters. In one embodiment, the disclosure relates to a dairy product comprising two or more butters, with each butter being a different color. In another embodiment, the dairy product is a butter product. In one embodiment, the disclosure relates to a butter/butter product, wherein the butter/butter product is a butter with a marbled appearance or pattern.

In one embodiment, the disclosure relates to a butter product comprising a first butter having a first color and a second butter having a second color, wherein the first color and second color are different colors. In another embodiment, the first butter and the second butter are in a marbled pattern, with distinct areas of the first color and distinct areas of the second color.

In one embodiment, the disclosure relates to a butter product comprising: a marbled pattern of a first butter that is white or whitish in color and a second butter that is yellow in color. In one embodiment, the butter product has distinct areas of white or whitish color and distinct areas of yellow color.

In one embodiment, the disclosure relates to a butter product comprising: a marbled pattern of a first butter having a first color and a second butter having a second color, wherein the first color and second color are different colors. In one embodiment, the butter product has distinct areas of the first color and distinct areas of the second color.

In one embodiment, the disclosure relates to a butter product comprising: a first butter having a white or whitish color and a second butter having a brown color, wherein the first butter and the second butter are in a marbled pattern with areas of white or whitish color and areas of brown color.

In one embodiment, the disclosure relates to a vegan butter.

In another embodiment, the disclosure relates to a butter product comprising a first butter that has first color and a second butter that has a second color, wherein the second color is a lighter color as compared to the first color.

In another embodiment, the disclosure relates to a butter product comprising a first butter that has first color and a second butter that has a second color, wherein the second color is a darker color as compared to the first color.

In yet another embodiment, the disclosure relates to a butter or a butter product comprising a first butter that is yellow in color and a second butter that is white or whitish in color. In one embodiment, the butter product has distinct areas of yellow color and distinct areas of white or whitish color.

In one embodiment, the disclosure relates to a dairy product comprising a first margarine/spreadable butter/butter blend having a first color and a second margarine/spreadable butter/butter blend having a second color, wherein the first color and second color are distinct colors. In one embodiment, the dairy product has distinct areas of the first color and distinct areas of the second color.

In another embodiment, the disclosure relates to a dairy product comprising a first margarine/spreadable butter/butter blend that has first color and a second margarine/spreadable butter/butter blend that has a second color, wherein the second color is a lighter color as compared to the first color.

In another embodiment, the disclosure relates to a dairy product comprising a first margarine/spreadable butter/butter blend that has first color and a second margarine/spreadable butter/butter blend that has a second color, wherein the second color is a darker color as compared to the first color.

In yet another embodiment, the disclosure relates to a dairy product comprising a first margarine/spreadable butter/butter blend that is yellow in color and a second margarine/spreadable butter/butter blend that is white or whitish in color.

In one embodiment, the yellow color can be a deep yellow color. In another embodiment, the yellow color can be a dark, deep, yellow color.

In yet another embodiment, the disclosure relates to a butter product comprising a butter that is yellow in color and a butter that is white or whitish in color. In yet another embodiment, the disclosure relates to a butter product comprising a first butter that is deep yellow in color and a second butter that is pale yellow in color.

In still another embodiment, the disclosure relates to a butter product having at least three butters, with each butter having a distinct color. In another embodiment, the disclosure relates to a butter product having at least two butters, a first butter that is white or whitish in color and a second butter that is yellow in color. In another embodiment, the butter product has a marbled appearance or pattern.

In one embodiment, the disclosure relates to a butter having a marble appearance comprising a first butter having a first color and a second butter having a second color. In one embodiment, the first butter is a butter that is white or whitish and the second butter is butter that is yellow. In one embodiment, the butter/butter product has distinct areas of the first color and distinct areas of the second color.

In one embodiment, the first butter is initially a white or whitish butter that has been changed to a new color other than white or whitish and the second butter is a white or whitish in color. In another embodiment, the first butter is initially a butter that is yellow in color that has been changed to a new color other than yellow and the second butter is a butter that is yellow in color.

In one embodiment, the butter can be changed to a new color through the addition of a natural dye, or an artificial dye, or a chemical process, or an addition of a food, or an addition of a fruit, or an addition of a vegetable, or an addition of herb, or combinations thereof.

In one embodiment, the disclosure relates to a butter having a marbled appearance comprising a first butter having a white or whitish color and a second butter having a yellow color. In one embodiment, the butter has distinct areas of white or whitish color and distinct areas of yellow color.

In one embodiment, the disclosure relates to a butter having a marbled appearance comprising a first butter having a white or whitish color and a second butter having a red color. In one embodiment, the butter has distinct areas of white or whitish color and distinct areas of red color.

In one embodiment, the disclosure relates to a butter having a marbled appearance comprising a first butter having a white or whitish color and a second butter having a brown color. In one embodiment, the butter has distinct areas of white or whitish color and distinct areas of brown color.

In one embodiment, the disclosure relates to a butter having a marbled appearance comprising a first butter having a white or whitish color and a second butter having a green color. In one embodiment, the butter has distinct areas of white or whitish color and distinct areas of green color.

In one embodiment, the disclosure relates to a dairy product having a marbled appearance comprising a first margarine/spreadable butter/butter blend having a first color and a second margarine/spreadable butter/butter blend having a second color. In one embodiment, the dairy product has distinct areas of the first color and distinct areas of the second color.

In one embodiment, the disclosure relates to a dairy product having a marbled appearance comprising a first margarine/spreadable butter/butter blend having a white or whitish color and a second margarine/spreadable butter/butter blend having a yellow color.

In one embodiment, the disclosure relates to a method for making a butter product comprising: blending or layering a first butter and a second butter; pressing the butters to remove air pockets. In another embodiment, the method further comprises chilling the pressed product to allow the butter to set. In another embodiment, the method further comprises removing or shaving residual butter from the pressed product.

In one embodiment, the disclosure relates to a method for making a butter product comprising: blending or layering a first butter with a first color and a second butter with a second color; and pressing the blended butters to remove air pockets to create a butter with a marbled appearance.

In one embodiment, the disclosure relates to a method for making a butter product comprising: blending or layering a first butter with a first color and a second butter with a second color; pressing the blended butters to remove air pockets; and chilling the pressed product to allow the blended butter to set and create a butter with a marbled appearance.

In one embodiment, the disclosure relates to a method for making a butter product comprising: blending or layering a first butter with a first color and a second butter with a second color; pressing the blended butters to remove air pockets; chilling the pressed product to allow the blended butter to set; and shaving residual residue from the chilled pressed product to create a butter with a marbled appearance.

In one embodiment, the disclosure relates to a method for making a butter product comprising: blending or layering a first butter with a white or whitish color and a second butter with a yellow color; and pressing the blended butters to remove air pockets to create a butter with a marbled appearance of white and yellow color.

In one embodiment, the disclosure relates to a method for making a butter product comprising: blending or layering a first butter with a white or whitish color and second butter with a yellow color; pressing the blended butters to remove air pockets; and chilling the pressed product to allow the blended butter to set and to create a butter with a marbled appearance of white and yellow color.

In one embodiment, the disclosure relates to a method for making a butter product comprising: blending or layering a first butter with a white or whitish color and a second butter with a yellow color; pressing the blended butters to remove air pockets; chilling the pressed product to allow the blended butter to set; and shaving residual butter from the chilled pressed product to create a butter with a marbled appearance of white and yellow color.

In one embodiment, the blending is by extrusion. In one embodiment, the extrusion is through a butter extruder. In another embodiment, the extrusion is through a press or a sausage press. In another embodiment, the blending is by grating the butter. In one embodiment, the blending is by cutting the butter.

In another embodiment, the blending is performed with frozen butter or chilled butter or soft butter. In another embodiment, the blending maintains the distinct color of the first butter and distinct color of the second butter.

Other embodiments will be evident from a consideration of the drawings taken together with the detailed description provided herein.

### BRIEF DESCRIPTION OF THE DRAWINGS

Embodiments of the disclosure are disclosed with reference to the accompanying drawings and are for illustrative purposes only. The disclosure is not limited in its application to the details of construction, or the arrangement of the components illustrated in the drawings. The disclosure is capable of other embodiments or of being practiced or conducted in other various ways. Like reference numerals are used to indicate like components. In the drawings:

FIG. 1 is a representative photograph of a butter product having a butter that is white/whitish in color and second butter that is yellow in color and displaying a marbled pattern in accordance with embodiments of the disclosure.

FIG. 2A is a representative photograph of a pressed butter having butter that is white/whitish in color and a butter that is yellow in color in accordance with embodiments of the disclosure.

FIG. 2B is a representative photograph showing a cut-away image of the butter product with butter that is white/whitish in color and butter that is yellow in color in accordance with embodiments of the disclosure.

FIG. 3A is a representative photograph of two cake frosting bags, one with butter that is white/whitish in color and one with butter that is yellow in color in accordance with embodiments of the disclosure.

FIG. 3B is a representative photograph of extruded butter that is white/whitish in color and butter that is yellow in color in a random, layered fashion in accordance with embodiments of the disclosure.

FIG. 3C is a representative photograph of a pressed butter product having butter that is white/whitish in color and butter that is yellow in color in accordance with embodiments of the disclosure.

FIG. 3D is a representative photograph of the butter product having butter that is white/whitish in color and butter that is yellow in color and having a marbled pattern throughout the product in accordance with embodiments of the disclosure.

FIG. 4A is a representative photograph of a butter that is yellow in color with the addition of a yellow dye and a butter that is white/whitish in color.

FIG. 4B is a representative photograph of a butter that is white/whitish in color and a butter with the addition of a yellow dye in a cake frosting bag, with the bag having a ribbon tip, #103 tip.

FIG. 4C is a representative photograph of a butter that is white/whitish in color and a butter with the addition of a yellow dye in a cake frosting bag, with the bag having a #101 tip.

FIG. 4D is a representative photograph of a butter that is white/whitish in color and a butter with the addition of a yellow dye that was extruded using a #103 tip in a random layered fashion in accordance with embodiments of the disclosure.

FIG. 4E is a representative photograph of a butter that is white/whitish in color and a butter with the addition of a yellow dye that was extruded using a #101 tip in a random layered fashion in accordance with embodiments of the disclosure.

FIG. 4F is a representative photograph of the butter product having a butter that is white/whitish in color and a butter with the addition of a yellow dye and having a marbled pattern throughout the product in accordance with embodiments of the disclosure. The marbled pattern of white and yellow color was achieved using a #103 tip at the end of the frosting bag.

FIG. 4G is a representative photograph of the blended butter product having a butter that is white/whitish in color and a butter with the addition of a yellow dye and having a marbled pattern throughout the product in accordance with embodiments of the disclosure. The marbled pattern of yellow and white color was achieved using a #101 tip at the end of the frosting bag.

FIG. 5A is a representative photograph of a butter that is white/whitish in color and a butter with the addition of a yellow dye in a cake frosting bag, with the bag having a #59 tip.

FIG. 5B is a representative photograph of a butter that is white/whitish in color and a butter with the addition of a yellow dye that was extruded using a #59 tip in a random layered fashion in accordance with embodiments of the disclosure.

FIG. 5C and FIG. 5D are representative photographs of the butter product having a butter that is white/whitish in color and a butter with the addition of a yellow dye and having a marbled pattern of yellow and white colors throughout the product in accordance with embodiments of the disclosure. The marbled pattern of yellow and white colors was achieved using a #59 tip at the end of the frosting bag.

FIG. 6A is a representative photograph of a first butter that has been dyed green and a second butter, which is white/whitish in color, in accordance with embodiments of the disclosure.

FIG. 6B is a representative photograph of a butter product with butter that has been dyed green and a butter that is white/whitish in color showing clear demarcations of the green butter and the white butter. The butter that was dyed green and the butter with a white/whitish color did not blend together.

FIG. 7 is a representative photograph of a butter product having a first butter with a yellow color, a second butter with a blueish to greenish color, and a third butter with a pinkish color, in accordance with embodiments of the disclosure. Each of the three butters maintained their distinct colors.

FIG. 8A is a representative photograph of a first butter that was initially white or whitish in color to which cherry cake and pastry filling was added, making a first butter with a red color.

FIG. 8B is a representative photograph of a first butter with a red color and a second butter that is white or whitish in color in cake frosting bags, with each bag having a ribbon tip, #103 tip.

FIG. 8C and FIG. 8D are representative photographs of a first butter with a red color and a second butter with a white/whitish color that was extruded using a #103 tip in a random layered fashion in accordance with embodiments of the disclosure.

FIG. 8E is a representative photograph of a pressed butter product having a marbled appearance of red and white colors in accordance with embodiments of the disclosure.

FIG. 8F is a representative photograph of the butter product having a marbled pattern of red and white colors throughout the product in accordance with embodiments of the disclosure. The marbled pattern was achieved using a #103 tip at the end of the frosting bag.

FIG. 9A is a representative photograph of a first butter with a white or whitish color and a second butter that was initially white/whitish in color to which cinnamon was added to make a butter that is brown in color in cake frosting bags, with each bag having a ribbon tip, #103 tip.

FIG. 9B and FIG. 9C are representative photographs of a first butter with a white or whitish butter and a second butter with a brown color that was extruded using a #103 tip in a random layered fashion in accordance with embodiments of the disclosure.

FIG. 9D and FIG. 9E are representative photographs of a pressed butter product having a marbled pattern of brown and white colors in accordance with embodiments of the disclosure.

FIG. 9F and FIG. 9G are representative photographs of the butter product having a marbled appearance of brown and white colors throughout the product in accordance with embodiments of the disclosure. The marbled pattern was achieved using a #103 tip at the end of the frosting bag.

FIG. 10A is a representative photograph of a first butter with a yellow color with the addition of annatto, making a first butter with a deep, rich yellow color.

FIG. 10B is a representative photograph of a first butter with a deep, rich yellow color and a second butter with a white/whitish color in cake frosting bags, with each bag having a ribbon tip.

FIG. 10C is a representative photograph of a butter product having a first butter with a deep, rich yellow color and a second butter with a white/whitish color and having a marbled pattern throughout the product in accordance with embodiments of the disclosure. The marbled pattern was achieved using a tip at the end of the frosting bag. The marbled pattern was achieved at temperatures of 41.4 degrees with a diameter pipe of 2 inches.

FIG. 10D is a representative photograph of the blended butter product having a first butter with a more yellow color and a second butter with a white/whitish color and having a marbled pattern throughout the product in accordance with embodiments of the disclosure. The marbled pattern was achieved using a ribbon tip at the end of the frosting bag. The marbled pattern was achieved at temperatures of 50.5 degrees with a diameter pipe of 1.5 inches.

Before explaining embodiments of the disclosure in detail, it is to be understood that the disclosure is not limited in its application to the details of construction and the arrangement of the components set forth in the following description or illustrated in the drawings. The technology of this present disclosure is capable of other embodiments or being practiced or conducted in various ways. Also, it is to be understood that the phraseology and terminology employed herein is for the purpose of description and should not be regarded as limiting.

### DETAILED DESCRIPTION

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

The numerical ranges in this disclosure are approximate, and thus may include values outside of the range unless otherwise indicated. Numerical ranges include all values from and including the lower and the upper values (unless specifically stated otherwise), in increments of one unit, provided that there is a separation of at least two units between any lower value and any higher value. As an example, if a compositional, physical or other property, such as, for example, distance, speed, velocity, etc., is from 10 to 100, it is intended that all individual values, such as 10, 11, 12, etc., and sub ranges, such as 10 to 44, 55 to 70, 97 to 100, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the amount of various components in a product.

Spatial terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of device in use or operation in addition to the orientation depicted in the figures. For example, if the device is turned over, elements described as “below,” or “beneath” other elements or features would then be orientated “above” the other elements or features. Thus, the exemplary term “below” can encompass both an orientation of above and below. The device may be otherwise oriented (rotated 90° or at other orientations) and the spatially relative descriptors used herein interpreted accordingly.

It will be understood that when an element or layer is referred to as being “on,” “connected to,” or “coupled to” another element or layer, it can be directly on, connected to or coupled to the other element or layer. Alternatively, intervening elements or layers may be present. In contrast, when an element or layer is referred to as being “directly on,” “directly connected to,” or “directly coupled to” another element or layer, there are no intervening elements or layers present.

As used herein, the term “and/or” includes any and all combinations of one or more of the associated listed terms. For example, when used in a phrase such as “A and/or B,” the phrase “and/or” is intended to include both A and B; A or B; A (alone); and B (alone). Likewise, the term “and/or” as used in a phrase such as “A, B and/or C” is intended to encompass each of the following embodiments: A, B and C; A, B, or C; A or C; A or B; B or C; A and C; A and B; B and C; A (alone); B (alone); and C (alone).

As used herein, the term “cream” means the liquid milk product high in fat separated from milk which may have been adjusted by adding thereto: milk, concentrated milk, dry whole milk, skim milk, concentrated skim milk, nonfat dry milk or other GRAS ingredients. “Whey cream” is the liquid milk product high in fat separated from whey (cheese, casein, or other), which may have been adjusted by adding thereto: whey, concentrated whey, dry whey, or other GRAS ingredients. “Pro-cream” is the liquid milk product high in fat collected as retentate from a whey filtration process such as microfiltration which may have been adjusted by adding thereto: whey, concentrated whey, dry whey, or other GRAS ingredients.

As used herein, the term “hue” refers to the quality of a color as determined by its dominant wavelength (“DW”). Exemplary hues include yellow, magenta, cyan, blue, green, and red.

As used herein, the term “marbled” refers to a pattern consisting of lines, areas, and lines and areas of two or more colors. In one embodiment, a butter product with a marbled pattern refers to a butter with areas of a first color and areas of a second color, wherein the first color and the second color are different colors (not the same color). In one embodiment, a butter product with a marbled pattern refers to a butter with areas of a butter with a white or whitish color and areas of butter with a yellow color. The terms “marbled” and “marble” are used interchangeably.

As used herein, the phrase “uniform profile” refers to the homogeneity of the characteristics of a product, including but not limited to shape, size, volume, weight, density, or mass of a product. In one embodiment, a uniform profile includes but is not limited to 100% of the product having the same characteristics, 50-99% of the product having the same characteristics, 60-99% of the product having the same characteristics, 65-99% of the product having the same characteristics, 70-99% of the product having the same characteristics, 75-99% of the product having the same characteristics, 80-99% of the product having the same characteristics, 85-99% of the product having the same characteristics, and 90-99% of the product having the same characteristics. In another embodiment, a uniform profile includes but is not limited to 95-99% of the product having the same characteristics, 92-95% of the product having the same characteristics, 87-92% of the product having the characteristics, 84-87% of the product having the same characteristics, 81-84% of the product having the same characteristics, 78-81% of the product having the same characteristics, 75-78% of the product having the same characteristics, 72-75% of the product having the same characteristics, 69-72% of the product having the same characteristics, 66-69% of the product having the same characteristics, 63-66% of the product having the same characteristics, 60-63% of the product having the same characteristics, 57-60% of the product having the same characteristics, 54-57% of the product having the same characteristics, 51-54%, and 50-51% of the product having the same characteristics.

As used herein, “white” is considered a color, and a “white” color may be a color commonly perceived as white.

As used herein, “whitish” refers to a color that that is very pale and almost white in color.

As used herein, “yellow” refers to a hue having a DW of 565 to 590 nanometers.

In one embodiment, the disclosure relates to a dairy product made of more than one butter. In one embodiment, the dairy product has a marbled pattern. In one embodiment, the dairy product is a butter product. In one embodiment, the product comprises at least two butters with each butter having a different color as compared to each other. In still another embodiment, the product comprises two or more butters all with different colors as compared to each other.

In one embodiment, the product comprises at least three butters with each butter having a different color as compared to each other. In still another embodiment, the product comprises three or more butters, all with different colors as compared to each other.

Butter with a Marbled Pattern

In one embodiment, the butter product comprises at least a first butter that is white or whitish in color and a second butter that is yellow in color. In one embodiment, the butter product comprises at least a first butter that is white or whitish in color and a second butter that is yellow in color in a marbled pattern of white and yellow colors. In one embodiment, the butter product comprises at least a first butter that is pale yellow in color and a second butter that is dark yellow in color in a marbled pattern of pale-yellow color and dark yellow color. In another embodiment, the butter product comprises a first butter that has a first color and a second butter that has a second color, wherein the second color is a lighter color as compared to the first color.

In one embodiment, the butter/butter product has distinct areas of white or whitish color and distinct areas of yellow color. In another embodiment, the butter/butter product has distinct areas of pale-yellow color and distinct areas of dark yellow color. In another embodiment, the butter/butter product has distinct areas of the first color and distinct areas of the second color.

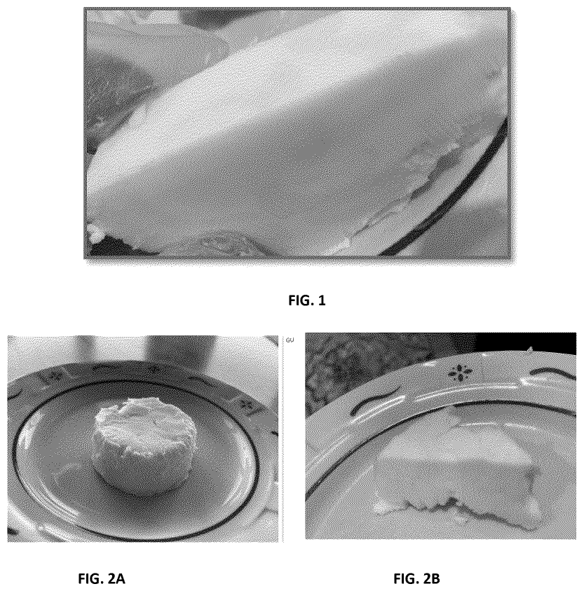

FIG. 1 provides a representative photograph of a butter product having a marbled pattern with a first butter that is white or whitish in color and a second butter that is yellow in color. In one embodiment, the marbled pattern is stable over time; the colors do not blend together. In one embodiment, the marbled dairy product has discrete patterns of yellow and white colors.

In one embodiment, the marbled butter product consists of only butter that is white or whitish in color and butter that is yellow in color. In one embodiment, the marbled butter product does not contain a dye or food coloring.

In another embodiment, the marbled butter product comprises only cream and salt. In one embodiment, a dye or chemical additive has not been added to the marbled butter product.

In yet another embodiment, the marbled butter product comprises cream, salt and one or more dyes.

In another embodiment, the marbled butter product comprises cream, salt, one or more dyes, and one or more flavorings.

In one embodiment, the marbled butter product comprises a first butter that is white or whitish in color, wherein said first butter is 5-10% or 10-15% or 15-20% or 20-25% or 25-30% or 30-35% or 35-40% or 40-45% or 45-50% or 50-55% or 55-60% or 60-65% or 65-70% or 70-75% or 75-80% or 80-85%, or 85-90% or 90-95%, or greater than 95% of the marbled butter product.

In one embodiment, the butter that is white or whitish in color is at least 35% or at least 45% or at least 55% or at least 65% or at least 75% of the marbled butter product.

In one embodiment, the butter that is white or whitish in color is from 25% to 85% of the marbled butter.

In one embodiment, the marbled butter product comprises a second butter that is yellow in color, wherein said second butter is 5-10% or 10-15% or 15-20% or 20-25% or 25-30% or 30-35% or 35-40% or 40-45% or 45-50% or 50-55% or 55-60% or 60-65% or 65-70% or 70-75% or 75-80% or 80-85%, or 85-90% or 90-95%, or greater than 95% of the marbled butter product.

In one embodiment, the butter that is yellow in color is at least 35% or at least 45% or at least 55% or at least 65% or at least 75% of the marbled butter product.

In one embodiment, the butter that is yellow in color is from 25% to 85% of the marbled butter.

In one embodiment, the marbled butter product comprises butter that is pale yellow in color, wherein said butter is 5-10% or 10-15% or 15-20% or 20-25% or 25-30% or 30-35% or 35-40% or 40-45% or 45-50% or 50-55% or 55-60% or 60-65% or 65-70% or 70-75% or 75-80% or 80-85%, or 85-90% or 90-95%, or greater than 95% of the marbled butter product.

In one embodiment, the butter that is pale yellow in color is at least 35% or at least 45% or at least 55% or at least 65% or at least 75% of the marbled butter product.

In one embodiment, the butter that is pale yellow in color is from 25% to 85% of the marbled butter.

In one embodiment, the marbled butter product comprises butter that is deep, dark yellow in color, wherein the deep, dark, yellow butter is 5-10% or 10-15% or 15-20% or 20-25% or 25-30% or 30-35% or 35-40% or 40-45% or 45-50% or 50-55% or 55-60% or 60-65% or 65-70% or 70-75% or 75-80% or 80-85%, or 85-90% or 90-95%, or greater than 95% of the marbled butter product.

In one embodiment, the butter that is deep, dark yellow in color is at least 35% or at least 45% or at least 55% or at least 65% or at least 75% of the marbled butter product.

In one embodiment, the butter that is deep, dark yellow in color is from 25% to 85% of the marbled dairy product.

In one embodiment, the marbled butter product comprises a first butter with a first color, wherein the first color is 5-10% or 10-15% or 15-20% or 20-25% or 25-30% or 30-35% or 35-40% or 40-45% or 45-50% or 50-55% or 55-60% or 60-65% or 65-70% or 70-75% or 75-80% or 80-85%, or 85-90% or 90-95%, or greater than 95% of the marbled butter product.

In one embodiment, the first butter with a first color is at least 35% or at least 45% or at least 55% or at least 65% or at least 75% of the marbled butter product.

In one embodiment, the first butter with a first color is from 25% to 85% of the marbled butter product.

In one embodiment, the marbled butter product comprises a second butter with a second color, wherein the second color is 5-10% or 10-15% or 15-20% or 20-25% or 25-30% or 30-35% or 35-40% or 40-45% or 45-50% or 50-55% or 55-60% or 60-65% or 65-70% or 70-75% or 75-80% or 80-85%, or 85-90% or 90-95%, or greater than 95% of the marbled butter product.

In one embodiment, the second butter with a second color is at least 35% or at least 45% or at least 55% or at least 65% or at least 75% of the marbled butter product.

In one embodiment, the second butter with a second color is from 25% to 85% of the marbled dairy product.

In another embodiment, the marbled butter product comprises a first butter that is white or whitish in color and a second butter that is yellow in color and is a compound butter or herb butter.

In one embodiment, the marbled butter product comprises a first butter that was initially white or whitish in color but was changed to a new color other than white or whitish and a second butter that is white or whitish in color. In another embodiment, the marbled butter product comprises a first butter that was initially white or whitish in color but was changed to a new color other than white or whitish and a second butter that is yellow in color.

In one embodiment, the butter can be changed to a new color through the addition of a natural dye, or an artificial dye, or a colorant, or an additive, or a chemical process, or a food, or a fruit, or a vegetable, or a herb, or a spice or combinations thereof.

In one embodiment, the change in color of the first butter from initially white/whitish in color to a new color may include, but is not limited to: white/whitish to yellow, white/whitish to orange, white/whitish to red, white/whitish to pink, white/whitish to magenta, white/whitish to purple, white/whitish to blue, white/whitish to turquoise, white/whitish to green, white/whitish to brown and white/whitish to black, among other white/whitish to colored transitions.

In one embodiment, the marbled butter product comprises a first butter that is initially yellow in color that is changed to a new color other than yellow and a second butter that is white or whitish in color. In another embodiment, the marbled butter product comprises a first butter that is initially yellow in color that is changed to a new color other than yellow and a second butter that is yellow in color. The change in color of the first butter from initially yellow in color to a new color may include, but is not limited to: yellow to orange, yellow to red, yellow to pink, yellow to magenta, yellow to purple, yellow to blue, yellow to turquoise, yellow to green, yellow to brown and yellow to black, among other white/whitish to colored transitions.

In one embodiment, one or more of the following synthetic dyes can be used as a colorant and added to a butter with a white/whitish color a butter with a yellow color:
(1) FD&C Blue No. 1—Brilliant blue FCF, E133 (blue shade)
(2) FD&C Blue No. 2—Indigotine, E132 (indigo shade)
(3) FD&C Green No. 3—Fast green FCF, E143 (turquoise shade)
(4) FD&C Red No. 3—Erythrosine, E127 (pink shade)
(5) FD&C Red No. 40—Allura red AC, E129 (red shade)
(6) FD&C Yellow No. 5—Tartrazine, E102 (yellow shade) and
(7) FD&C Yellow No. 6—Sunset yellow FCF, E110 (orange shade).

Table 1 below provides examples of common color additives in the US and the EU that can be used to change the initial color of a butter to a new color.

| US | EU | Color |
|---|---|---|
| Annatto extract | Annatto; Bixin; Norbixin | Yellow-orange |
| | (E160b) | |
| Dehydrated beets | Beetroot Red; Betanin | Dark red |
| (beet powder) | (E162) | |
| β-Carotene | Carotenes (E160a) | Yellow-orange |
| Cochineal extract; | Cochineal; Carminic | Red |
| carmine | acid; Carmines (E120) | |
| Ferrous gluconate | Ferrous gluconate (E579) | Black |
| Grape color extract | Anthocyanins (E163) | Purple-red |
| Paprika | Paprika extract; | Red |
| | Capsanthian; Capsorubin | |
| | (E160c) | |
| Riboflavin | Riboflavin; Riboflavin- | Yellow-orange |
| | 5′-phosphate (E101) | |
| Titanium dioxide | Titanium dioxide (E171) | White |
| Tomato lycopene; | Lycopene (E160d) | Red |
| tomato lycopene | | |
| concentrate | | |
| Turmeric | Curcumin (E100) | Yellow |

In one embodiment, the disclosure relates to a butter having a marbled appearance comprising a first butter that is red in color and a second butter that is white/whitish in color. In one embodiment, the disclosure relates to a butter having a marbled appearance comprising a first butter that is red in color and a second butter that is yellow in color.

In one embodiment, the disclosure relates to a butter having a marbled appearance comprising a first butter that is brown in color and a second butter that is white/whitish in color. In one embodiment, the disclosure relates to a butter having a marbled appearance comprising a first butter that is brown in color and a second butter that is yellow in color.

In one embodiment, the disclosure relates to a butter having a marbled appearance comprising a first butter that is green in color and a second butter that is white/whitish in color. In one embodiment, the disclosure relates to a butter having a marbled appearance comprising a first butter that is green in color and a second butter that is yellow in color.

In one embodiment, the disclosure relates to a butter having a marbled appearance comprising a first butter that is blue in color and a second butter that is white/whitish in color. In one embodiment, the disclosure relates to a butter having a marbled appearance comprising a first butter that is blue in color and a second butter that is yellow in color.

In one embodiment, the disclosure relates to a butter having a marbled appearance comprising a first butter that is orange in color and a second butter that is white/whitish in color. In one embodiment, the disclosure relates to a butter having a marbled appearance comprising a first butter that is orange in color and a second butter that is yellow in color.

In one embodiment, the disclosure relates to a butter having a marbled appearance comprising a first butter that is purple in color and a second butter that is white/whitish in color. In one embodiment, the disclosure relates to a butter having a marbled appearance comprising a first butter that is purple in color and a second butter that is yellow in color.

In one embodiment, the disclosure relates to a butter having a marbled appearance comprising a first butter that is a color ranging from a color from yellow to orange, orange to red, red to pink, pink to magenta, magenta to purple, purple to blue, blue to turquoise, turquoise to green, green to brown and brown to black and a second butter that is white/whitish in color. In one embodiment, the disclosure relates to a butter having a marbled appearance comprising a first butter that is a color ranging from a color from yellow to orange, orange to red, red to pink, pink to magenta, magenta to purple, purple to blue, blue to turquoise, turquoise to green, green to brown and brown to black and a second butter that is yellow in color.

In one embodiment, the butter having a marbled appearance can be molded into any desired shape or size including but not limited to Christmas trees, angels, snowmen, bells, ornament balls, gingerbread girls and boys, presents, Christmas wreaths, Menorah or Star of David, a heart, a shamrock, Easter eggs, doves, rabbits, Easter baskets, a flag, pumpkins, cats, ghosts, turkeys, acorns, mascots, sporting mascots, college or university insignia, professional sports teams insignia, mascots for professional sports teams. There is virtually no limit to the shape that can be used, regardless of the particular holiday season, special occasion, or other special event at hand.

Note that the potential designs and shapes of the marbled butter are not limited to holiday themes. Special occasions and special events can also be represented in a multi-layer and/or colorful marbled butter design. Example special occasions include anniversaries or birthdays, where the design could include the relevant number of years and colorful surrounding detail (e.g., songbirds, ribbons, and presents). A wedding is another special occasion, where the design could include colorful flowers and doves. Example special events include sporting events such as the Super Bowl, where the design could include a multilayer, multi-color Super Bowl design (the number of the Super Bowl and the two team insignias). A housewarming gift is another special event, where the design could include the colorful, multi-layer detail of a cozy house. A company function is another special event, where the design could include a colorful and/or multi-layer company logo and recent achievement. In general, the design of the artistic marbled butter can be customized to capture any fanciful or otherwise artistic scene.

### Methods of Making a Marbled Butter

In one embodiment, the disclosure relates to a butter product having at least two butters, with each butter having a different color as compared to each other. In one embodiment, the disclosure relates to a butter product comprising two butters with the first butter being white or whitish in color and the second butter being yellow in color, which produces a marbled butter with white and yellow colors.

In one embodiment, the butter can be prepared using any method that produces a marbled pattern. In one embodiment, the butter can be prepared using any method provided the first butter and the second butter maintain their original colors.

In one embodiment, the disclosure relates to a method for making a marbled butter product comprising: blending or layering a first butter and a second butter; pressing the butters to remove air pockets. In another embodiment, the method further comprises chilling the butter product to allow the butter to set. In another embodiment, the method further comprises removing or shaving residual butter from the pressed product to produce a finished product.

### A. Blending the Butter

In one embodiment, a butter that is white or whitish in color and a butter that is yellow in color can be blended, mixed, combined, layered, or extruded together. By blending, mixing, combining, layering, or extruding together, the two butters are placed in contact with each other, but each butter maintains its original color. As used herein, blending, mixing, combining, layering, or extruding does not produce a product with a uniform, homogenous color.

In one embodiment, a butter that is white or whitish in color and a butter that is yellow in color can be extruded or blended or mixed or combined or layered together. Any suitable mechanism of blending can be used if it achieves a butter wherein the two butters maintain their original colors.

In one embodiment, the butter that is white or whitish in color and the butter that is yellow in color can be blended by extruding a layer of white butter followed by a layer of yellow butter. In one embodiment, the butter that is white/whitish in color and the butter that is yellow in color can be extruded in a random pattern. In another embodiment, the butter that is white/whitish in color and the butter that is yellow in color can be extruded in a specific, designed pattern.

In one embodiment, the butter that is white or whitish in color and the butter that is yellow in color can be grated or shaved or sliced together. In another embodiment, butter that is white or whitish in color can be cut into a uniform profile and then mixed with butter that is yellow in color that has been cut into a uniform profile.

In one embodiment, the temperature of the butter that is white or whitish in color and the butter that is yellow in color for blending is selected from the group consisting of: 5-15° F., 15-25° F., 25-30° F., 30-35° F., 35-45° F., 45-55° F., 55-60° F., 60-65° F., 65-70° F., 70-75° F., 75-80° F., 80-85° F., and 85-90° F.

In one embodiment, the temperature of the first butter with a first color and the second butter with a second color for blending is selected from the group consisting of: 5-15° F., 15-25° F., 25-30° F., 30-35° F., 35-45° F., 45-55° F., 55-60° F., 60-65° F., 65-70° F., 70-75° F., 75-80° F., 80-85° F., and 85-90° F.

In one embodiment, the temperature of the butter prior to blending is from 20° F. to 70° F. or from 25° F. to 65° F. or from 30° F. to 60° F. or from 35° F. to 55° F. or from 40° F. to 50° F. or from 45° F. to 50° F.

In one embodiment, the temperature of the butter prior to blending is from 20° F. to 65° F. or from 20° F. to 60° F. or from 20° F. to 55° F. or from 20° F. to 50° F. or from 20° F. to 45° F. or from 20° F. to 40° F. or from 20° F. to 35° F. or from 20° F. to 30° F. or from 20° F. to 25° F.

In one embodiment, the temperature of the butter prior to blending is from 25° F. to 70° F. or from 30° F. to 70° F. or from 35° F. to 70° F. or from 40° F. to 70° F. or from 45° F. to 70° F. or from 50° F. to 70° F. or from 55° F. to 70° F. or from 60° F. to 70° F. or from 65° F. to 70° F.

In one embodiment, the temperature of the butter prior to blending is from 35° F. to 60° F. or from about 40° F. to 65° F.

In one embodiment, the temperature of the butter prior to blending is about 40° F.

In yet another embodiment, the temperature of the butter prior to blending is selected from the group consisting of: 30° F., 31° F., 32° F., 33° F., 34° F., 35° F., 36° F., 37° F., 38° F., 39° F., 40° F., 41° F., 42° F., 43° F., 44° F., 45° F., 46° F., 47° F., 48° F., 49° F., 50° F., 51° F., 52° F., 53° F., 54° F., 55° F., 56° F., 57° F., 58° F., 59° F., 60° F., 61° F., 62° F., 63° F., 64° F., 65° F., 66° F., 67° F., 68° F., 69° F., 70° F., 71° F., 72° F., 73° F., 74° F., 75° F., 76° F., 77° F., 78° F., 79° F., 80° F., 81° F., 82° F., 83° F., 84° F., 85° F., 86° F., 87° F., 88° F., 89° F., and 90° F.

### (1) Frozen Butter

In one embodiment, frozen butter can be used when blending the two butters. In one embodiment, at least one butter is frozen. In another embodiment, the butter that is yellow in color and/or the butter that is white or whitish can be frozen.

In one embodiment, the frozen butter can be grated into small pieces or ribbons. In one embodiment, the frozen butter is grated or cut into a uniform profile. In another embodiment, one butter can be cut or grated into larger pieces as compared to the other butter. In one embodiment, the butter that is white or whitish in color can be cut or grated into larger pieces as compared to the butter that is yellow in color. In still another embodiment, the butter that is yellow in color can be cut or grated into larger pieces are compared to the butter that is white or whitish in color.

### (2) Chilled Butter

In another embodiment, chilled butter can be used when blending the two butters. In one embodiment, the butter can be cut into cubes, circles or other similar shapes. In one embodiment, the chilled butter can be cut into shapes with a uniform profile. In another embodiment, one chilled butter can be cut or grated into larger pieces as compared to the other chilled butter.

### (3) Soft Butter

In another embodiment, soft butter can be used when blending the two butters. The soft butter can be extruded through a tube, butter extruder or similar device in a variable manner.

### B. Pressing

In one embodiment, the blended butter is pressed to remove air pockets and to create a consistent texture. Any method of pressing can be used that produces a butter having a marbled pattern.

### C. Chilling

In another embodiment, the pressed dairy product is chilled. This step allows the butter to set. The chilling period can be any desired time period including but not limited to 1-10 min, 10-20 min, 20-30 min, 30 min, 30-60 min, 1-2 hours (hrs), 2-4 hrs, 4-6 hrs, 6-8 hrs, 8-10 hrs, 10-12 hrs, 12-24 hrs, 24-48 hrs and greater than 48 hours.

### D. Shaving

In one embodiment, after the butter is pressed, the butter can be shaved to remove any residual butter from the final product. The butter can then be cut into the desired portions for packing and sale.

### Further Additives

The dairy product may also contain further additives as needed. Examples of such components are buttermilk, synthetic or natural flavorings, natural flavorings, salt, spices, garlic, onions, and acidifiers and antioxidants.\

(A) Flavorings. The preparations disclosed herein may contain one or more flavorings. Typical examples include: acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidenephthalide, carvone, camphene, caryophyllene, cineol, cinnamyl acetate, citral, citronellol, citronellal, citronellyl acetate, cyclohexyl acetate, cymol, damascone, decalactone, dihydrocoumarin, dimethyl anthranilate, dodecalactone, ethoxyethyl acetate, ethylbutyric acid, ethyl butyrate, ethyl caprinate, ethyl capronate, ethyl crotonate, ethyl furaneol, ethyl guaiacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzyl acetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methyl butyric acid, 2-methylbutyl acetate, methyl caproate, methyl cinnamate, 5-methyl furfural, 3,2,2-methyl cyclopentenolone, 6,5,2-methyl heptenone, methyl dihydrojasmonate, methyl jasmonate, 2-methyl methyl butyrate, 2-methyl-2-pentenoic acid, methylthiobutyrate, 3,1-methylthiohexanol, 3-methylthiohexyl acetate, nerol, neryl acetate, trans, trans, 2,4-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovalerate, piperonal, propionaldehyde, propyl butyrate, pulegone, pulegol, sinensal, sulphurol, terpinene, terpineol, terpinolene, 8,3-thiomenthanone, 4,4,2-thiomethyl pentanone, thymol, delta-undecalactone, gamma-undecalactone, valencene, valeric acid, vanillin, acetoin, ethyl vanillin, ethyl vanillin isobutyrate (=3-ethoxy-4-isobutyryloxybenzaldehyde), 2,5-dimethyl-4-hydroxy-3 (2H)-furanone, and derivatives thereof (with homofuraneol (=2-ethyl-4-hydroxy-5-methyl-3 (2H)-furanone), homofuronol (=2-ethyl-5-methyl-4-hydroxy-3 (2H)-furanone, and 5-ethyl-2-methyl-4-hydroxy-3 (2H)-furanone being preferred), maltol and maltol derivatives (with ethyl maltol being preferred), coumarin and coumarin derivatives, gamma-lactones (with gamma-undecalactone, gamma-nonalactone, and gamma-decalactone being preferred), delta-lactones (with 4-methyl delta decalactone, massoia lactone, delta decalactone, and tuberose lactone being preferred), methyl sorbate, divanillin, 4-hydroxy-2 (or 5)-ethyl-5 (or 2)-methyl-3 (2H) furanone, 2-hydroxy-3-methyl-2-cyclopentenone, 3-hydroxy-4,5-dimethyl-2 (5H)-furanone, acetic acid isoamyl ester, butyric acid ethyl ester, butyric acid-n-butyl ester, butyric acid isoamyl ester, 3-methyl butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenyl glycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio) furan, 2-methyl-3-furanthiol, bis(2-methyl-3-furyl)disulphide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-di methylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3 (2H)-furanone, guaiacol, 3-hydroxy-4,5-dimethyl-2 (5H)-furanone, 3-hydroxy-4-methyl-5-ethyl-2 (5H)-furanone, cinnamaldehyde, cinnamyl alcohol, methyl salicylate, isopulegol, and (not explicitly mentioned here) stereoisomers, enantiomers, positional isomers, diastereomers, cis/trans-isomers, and/or epimers of these substances.

(B) Acidifiers and antioxidants. In accordance therewith, the following are examples of suitable acidifiers and/or antioxidants:
(1) E 300 Ascorbic acid
(2) E 301 Sodium ascorbate
(3) E 302 Calcium ascorbate
(4) E 304 Ascorbyl palmitate/ascorbyl stearate
(5) E 306 Tocopherol-containing extracts
(6) E 307 Alpha-tocopherol
(7) E 308 Gamma-tocopherol
(8) E 309 Delta-tocopherol
(9) E 310 Propyl gallate
(10) E 311 Octyl gallate
(11) E 312 Dodecyl gallate
(12) E 315 Isoascorbic acid
(13) E 316 Sodium isoascorbate
(14) E 319 tert-butyl hydroquinone
(15) E 320 Butylated hydroxyanisole (BHA)
(16) E 321 Butylated hydroxytoluene (BHT)
(17) E 322 Lecithin
(18) E 325 Sodium lactate
(19) E 326 Potassium lactate
(20) E 327 Calcium lactate
(21) E 330 Citric acid
(22) E 331 Mono-/di-/trisodium citrate
(23) E 332 Monopotassium citrate, tripotassium citrate
(24) E 333 Monocalcium citrate, dicalcium citrate, tricalcium citrate
(25) E 334 L (+)-tartaric acid
(26) E 335 Monosodium tartrate, disodium tartrate
(27) E 336 Monopotassium tartrate, dipotassium tartrat
(28) E 337 Potassium sodium tartrate
(29) E 338 Phosphoric acid
(30) E 339 Monosodium phosphate, disodium phosphate, trisodium phosphate
(31) E 340 Monopotassium phosphate, dipotassium phosphate, tripotassium phosphate
(32) E 341 Monocalcium phosphate, dicalcium phosphate, tricalcium phosphate
(33) E 343 Magnesium phosphate
(34) E 350 Sodium hydrogen malate, sodium malate
(35) E 351 Potassium malate
(36) E 352 Calcium malate, calcium hydrogen malate
(37) E 353 Metatartaric acid
(38) E 354 Calcium tartrate
(39) E 355 Adipic acid
(40) E 356 Sodium adipate
(41) E 357 Potassium adipate
(42) E 363 Succinic acid
(43) E 380 Ammonium citrate
(44) E 385 Calcium disodium methylene diamine tetrahydrate
(45) E 392 Rosemary extract

### Example 1

In this example, a butter that is yellow in color and a butter that is white or whitish in color was sliced in rectangular shapes, chilled and then pressed. However, the butter can be cut into any shape that allows for the production of a butter product with a marbled pattern. FIGS. 2A and 2B provide representative photographs of the blended butter product made of a butter that is yellow in color and a butter that is white in color. As shown in FIGS. 2A and 2B, the butter product has a marbled appearance with yellow and white colors distributed throughout the butter product.

### Example 2

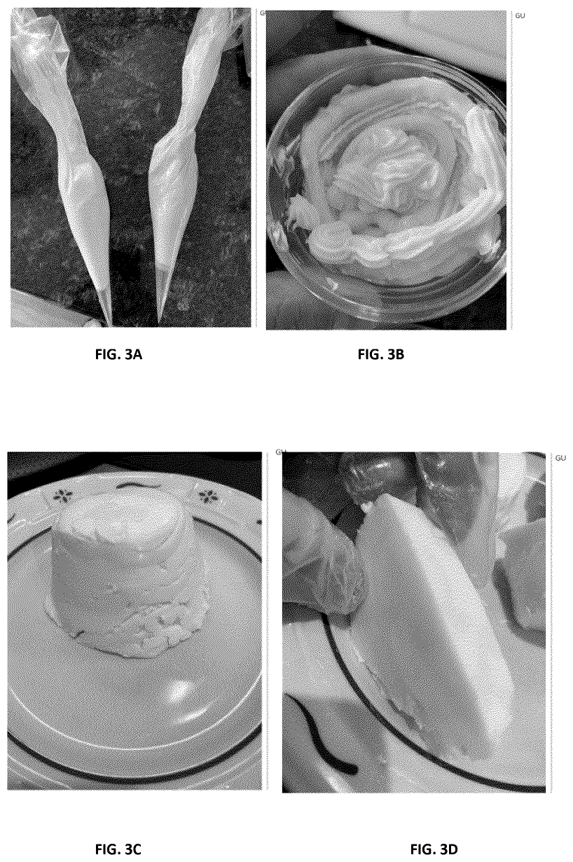

In this example, a butter that was yellow in color was placed in a first cake frosting bag and a butter that was white or whitish in color was placed in a second cake frosting bag (see FIG. 3A). A layer of yellow butter was extruded through the frosting bag followed by a layer of white butter. This process of alternative layering was continued for multiple cycles and a representative photograph is shown in FIG. 3B. A marbled pattern of yellow and white colors was achieved as shown in FIG. 3C and FIG. 3D.

### Example 3

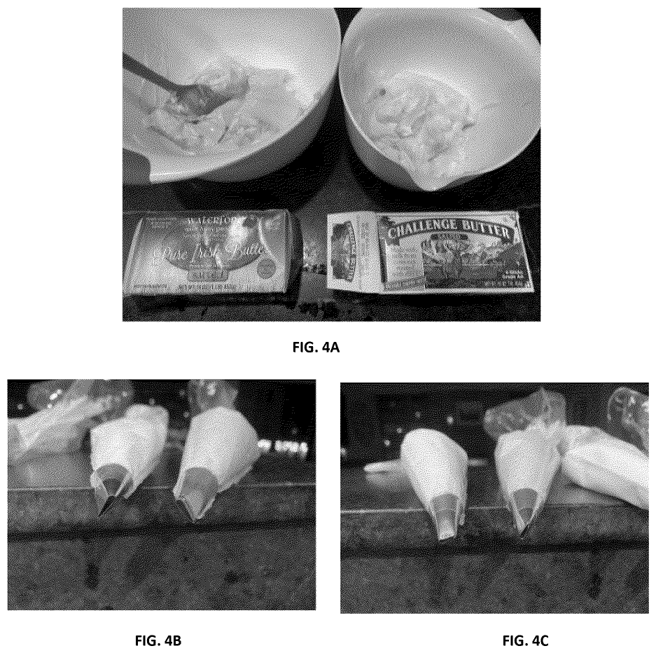

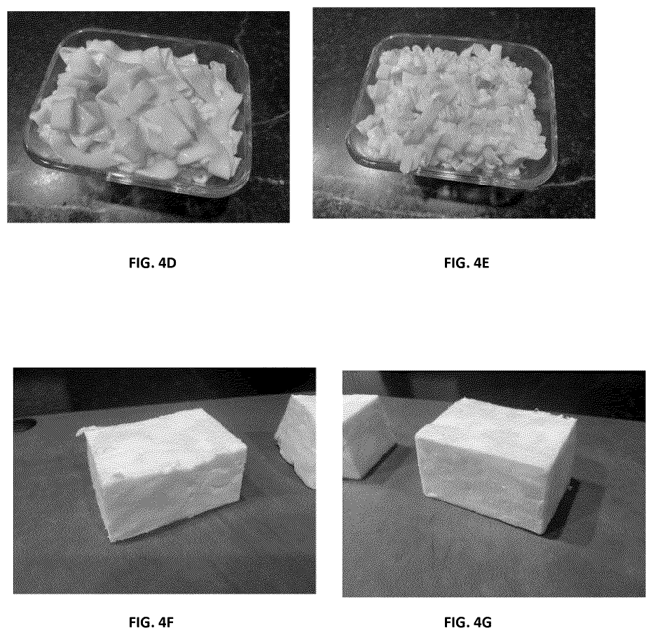

In this example, a marbled butter was made with a first butter having a white/whitish color and a second butter with a deep yellow color. Challenge butter was used as the butter that was white/whitish in color and Waterford Pure Irish butter was used as the yellow butter. Six drops of yellow food coloring was added to the Waterford Pure Irish butter (FIG. 4A) to produce a butter with a deep yellow color. While it is not necessary to add any dye or coloring to the butter product, the addition of dye aids in viewing of the photographs.

Butter that was yellow in color and the butter that was white/whitish in color were each placed into two different cake frosting bags, for a total of four frosting bags, two with butter that is yellow in color and two with butter that was white or whitish in color. A #103 ribbon tip was placed on a yellow butter frosting bag and a white butter frosting bag (FIG. 4B). A #101 ribbon tip was placed on a yellow butter frosting bag and a white butter frosting bag (FIG. 4C).

A layer of butter that was yellow in color was extruded through the frosting bag with #103 tip followed by a layer of butter that was white in color through a #103 tip. This process of alternative layering was continued for multiple cycles and a representative photograph is shown in FIG. 4D. Similarly, a layer of butter that was yellow in color was extruded through the frosting bag with #101 tip followed by a layer of butter that was white in color through a #101 tip. This process of alternative layering was continued for multiple cycles and a representative photograph is shown in FIG. 4E. The layering can occur in a random fashion or in a specific pattern.

For both a #103 and #101 tip, a marbled pattern of yellow and white colors was achieved as shown in FIG. 4F and FIG. 4G.

### Example 4

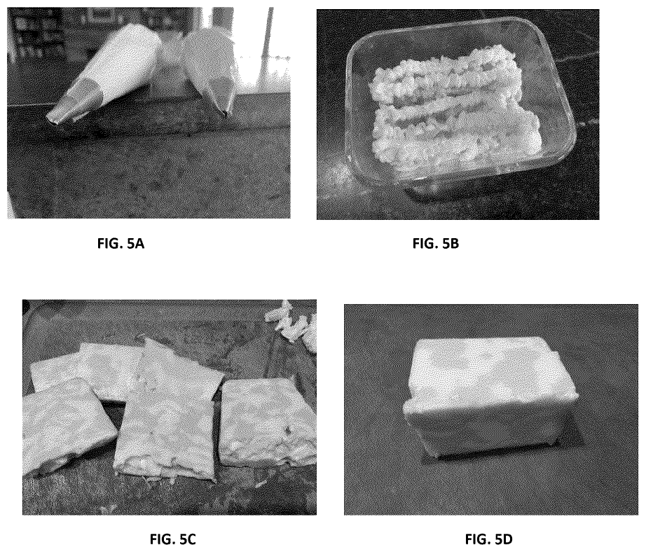

A marbled butter product having a first butter with a white/whitish color and a second butter with a yellow color was made. In this example, three drops of yellow dye were added to the second butter that was yellow in color to achieve a deeper, yellow color and a #59 tip was used to extrude the butter through the cake frosting bag (FIG. 5A and FIG. 5B). As shown in FIGS. 5C and 5D, a butter product of butter with a white/whitish color and a butter with a yellow color having a marbled pattern was achieved.

### Example 5

In this example, the stability of the marbled pattern of the butter product was evaluated. The experiment was designed to test if the butter with the white or whitish color and the butter with the yellow color would blend together to become one color, thereby losing the marbled pattern.

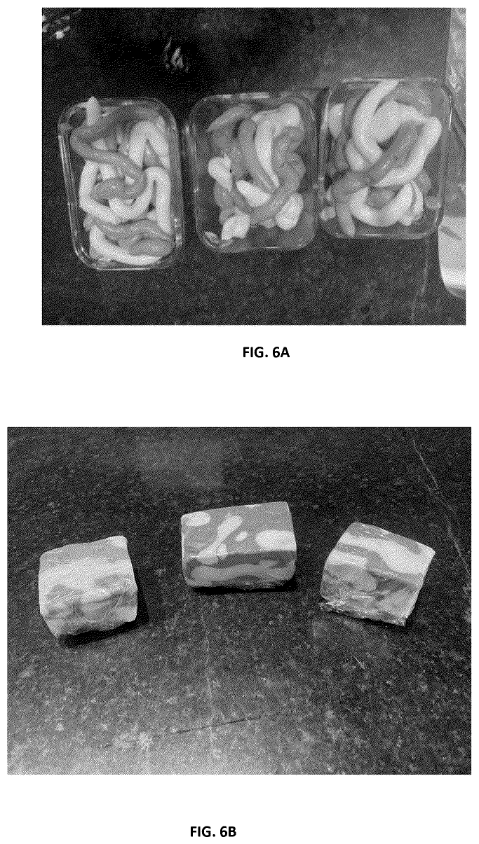

Green dye was added to a butter that had an initial yellow color to produce a butter with a green color. The butter with a green color and the butter with a white/whitish color were extruded through cake frosting bags having a ⅜″ circular tip (FIG. 6A). After pressing, the blended butter product was allowed to sit at room temperature. As shown in FIG. 6B, the two butters of the butter product remained distinct colors. There is a clear demarcation of the green butter from the white butter. A marbled pattern was maintained over time.

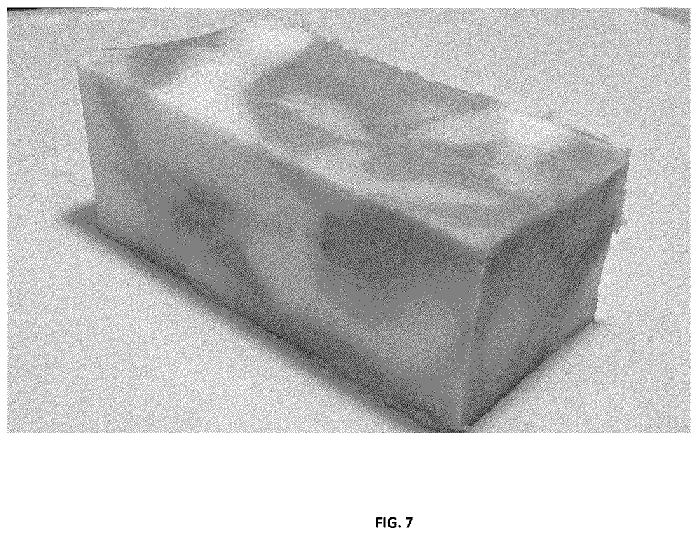

FIG. 7 is a representative photograph of a butter product showing a marbled pattern of three distinct colors. The butter product has a first butter with a yellow color, a second butter that had five drops of blue dye added, and a third butter that had five drops of red dye added. The butter product has a pattern consisting of three colors: a yellow color, a blueish-greenish color and a pinkish color, wherein each of the three colors are distributed throughout the product. Each of the first butter, second butter, and third butter maintain their distinct colors while creating a marbled pattern. The three colors remain unique and do not blend into a single color.

### Example 6

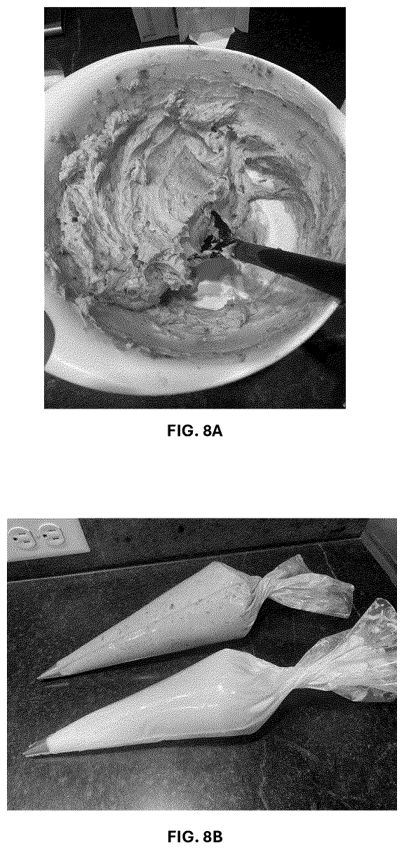

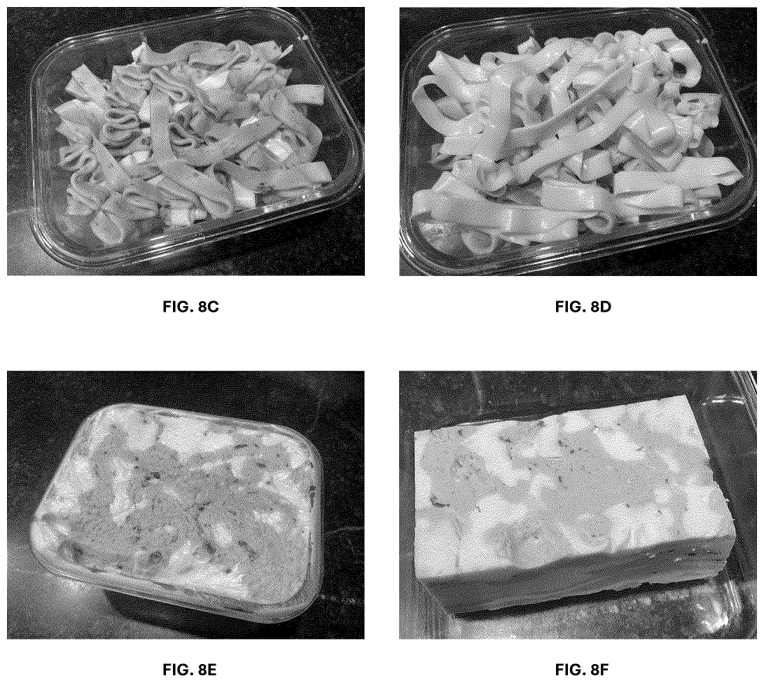

In this example, a marbled butter with a first butter having a red color and a second butter with a white color was made. To create the butter with a red color, a 12 oz. can of cherry cake and pastry filling was added to butter with a white/whitish color in create a first butter with a red color (FIG. 8A).

Butter that was red in color and a butter that was white/whitish in color were each placed into two different cake frosting bags. A #103 ribbon tip was placed on the red butter frosting bag and the white butter frosting bag (FIG. 8B).

A layer of butter that was red in color was extruded through the frosting bag with #103 tip followed by a layer of butter that was white in color through a #103 tip. This process of alternative layering was continued for multiple cycles and representative photographs are shown in FIG. 8C and FIG. 8D. The layering can occur in a random fashion or in a specific pattern.

The blended butter product was pressed (FIG. 8E), chilled and cut into a rectangular shape to show the butter product that has a marbled appearance with red and white colors distributed throughout (FIG. 8F).

### Example 7

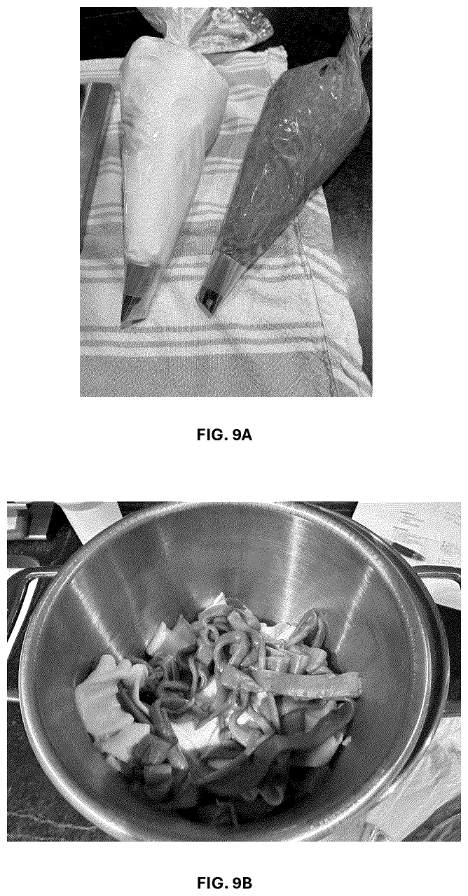

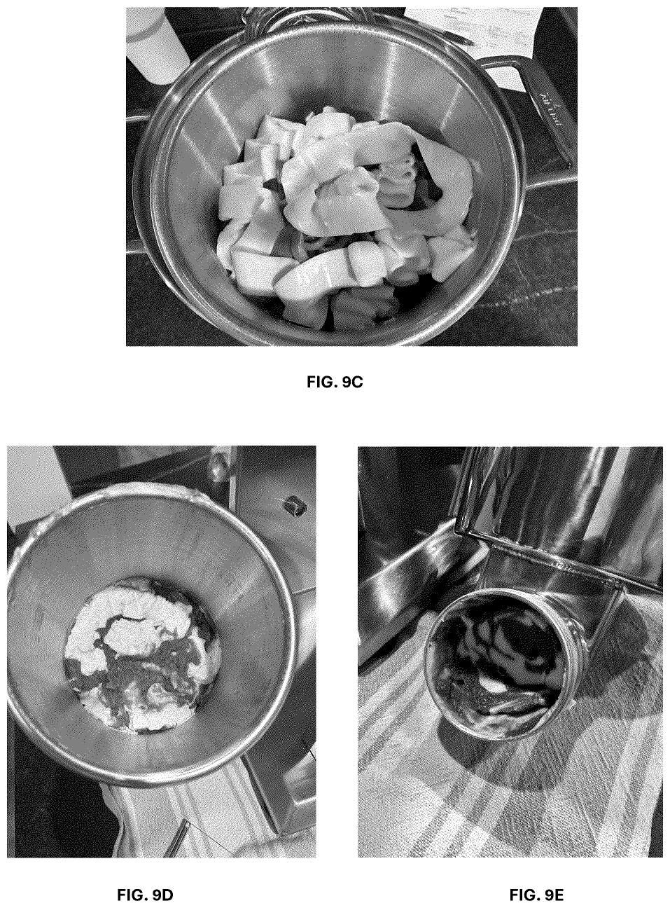

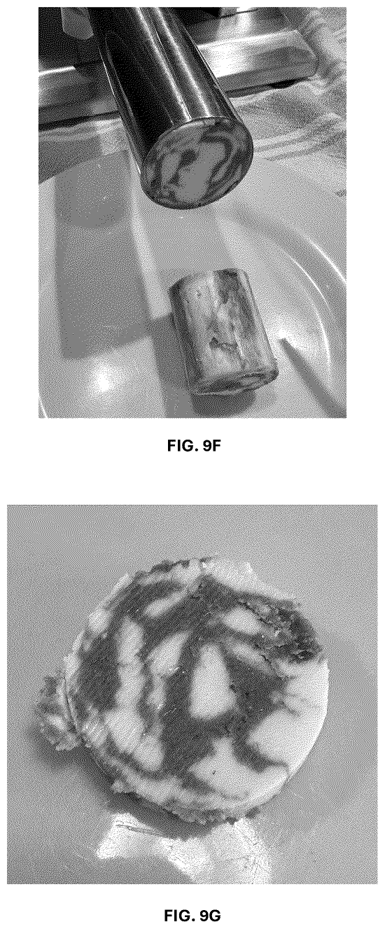

In this example, a marbled butter with a first butter having a brown color and a second butter with a white color was made. To generate the first butter having a brown color, a butter that was white in color was mixed with ground cinnamon creating a brown butter. The butter that was brown in color was placed in a first frosting bag and a butter that was white/whitish in color was placed in a frosting bag. A #103 ribbon tip was placed on a white butter frosting bag and a brown butter frosting bag (FIG. 9A).

A layer of butter that was brown in color was extruded through the frosting bag with #103 tip followed by a layer of butter that was white in color through a #103 tip. This process of alternative layering was continued for multiple cycles and representative photographs are shown in FIG. 9B and FIG. 9C. The layering can occur in a random fashion or in a specific pattern.

The blended butter product was pressed into and through a manual sausage press (FIG. 9D, FIG. 9E and FIG. 9F) into a cylinder shape that was cut to show the butter product that has a marbled appearance with brown and white colors distributed throughout (FIG. 9G).

### Example 8

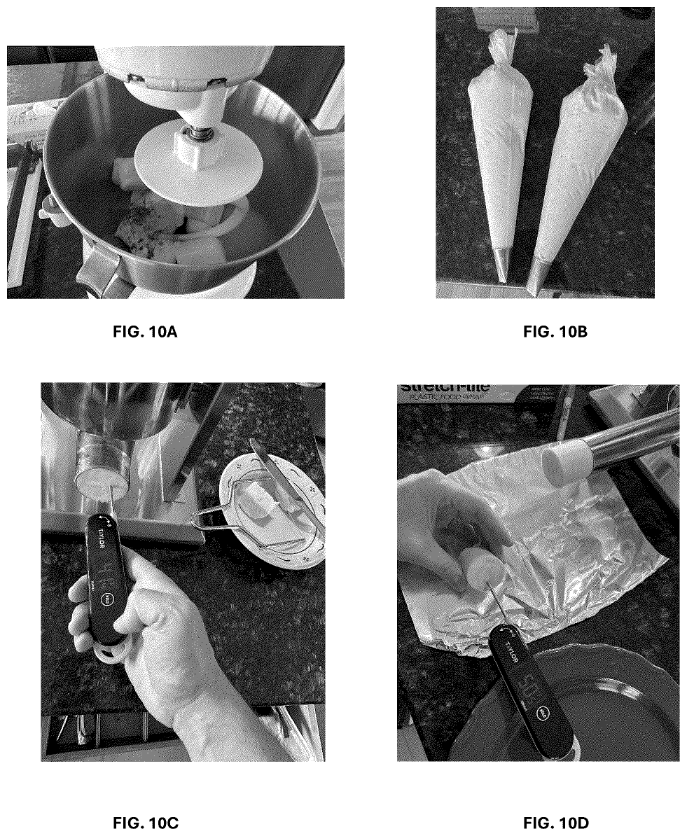

In this example, a marbled butter with a first butter having a deep yellow color and a second butter with a white color was made. To create the butter with a deep yellow color, annatto was added to a butter that was yellow in color (FIG. 10A). Alternatively, a butter with deep yellow butter can be created by adding annatto to a butter that is white in color.

A butter that was white/whitish in color was placed in a first frosting bag and a butter that was deep yellow in color was placed in a second frosting bag. A ribbon tip was placed on the white butter frosting bag and the deep yellow butter frosting bag (FIG. 10B).

A layer of butter that was deep yellow in color was extruded through the frosting bag with a ribbon tip followed by a layer of butter that was white/whitish in color through a ribbon tip. This process of alternative layering was continued for multiple cycles. Layering can occur in a random fashion or in a specific pattern. The blended butter product was pressed into and through a manual sausage press and into a cylinder shape that was 2 inches (FIG. 10C) and 1.5 inches (FIG. 10D), respectively. The blended butter was extruded at different temperatures of 41.4 degrees Fahrenheit (FIG. 10C) and 50.5 degrees Fahrenheit (FIG. 10D). The butter was then cut to show the blended butter product that has a marbled appearance with deep yellow and white colors distributed throughout (FIG. 10C and FIG. 10D).

While multiple embodiments of a butter product have been described in detail herein, it should be apparent that modifications and variations thereto are possible, all of which fall within the true spirit and scope of the invention. With respect to the above description then, it is to be realized that the optimum dimensional relationships for the parts of the butter product, methods and systems of this disclosure, to include variations in size, materials, shape, form, function and manner of operation, assembly and use, are deemed readily apparent and obvious to one of skill in the art, and all equivalent relationships to those illustrated in the drawings and described in the specification are intended to be encompassed by embodiments of the present disclosure. Further, since numerous modifications and changes will readily occur to those skilled in the art, it is not desired to limit the invention to the exact construction and operation shown and described, and accordingly, all suitable modifications and equivalents may be resorted to, falling within the scope of this disclosure.

What is claimed is:

1. A butter product comprising: a marbled pattern of a first butter that is white or whitish in color and a second butter that is yellow in color.

2. The butter product of claim 1, wherein the first butter is about 50% of the butter product.

3. The butter product of claim 1, wherein the first butter is from 30% to 40% of the butter product.

4. The butter product of claim 1, wherein the first butter is from 60% to 70% of the butter product.

5. The butter product of claim 1, wherein a yellow dye is added to the second butter.

6. A butter product comprising: a marbled pattern of a first butter having a first color and a second butter having a second color, wherein the first color and second color are different colors.

7. The butter product of claim 6, wherein the first color is brown, and the second color is white or whitish.

8. The butter product of claim 6, wherein the first color is red, and the second color is white or whitish.

9. The butter product of claim 6, wherein the first color is green, and the second color is white or whitish.

10. The butter product of claim 6, wherein the first color is created with a natural dye, or an artificial dye, or a chemical process, or a food, or a fruit, or a vegetable, or a herb, or a spice or combinations thereof.

11. The butter product of claim 6, wherein the first butter is about 50% of the butter product.

12. The butter product of claim 6, wherein the first butter is from 30% to 40% of the butter product.

13. The butter product of claim 6, wherein the first butter is from 60% to 70% of the butter product.

14. The butter product of claim 10, wherein the first butter is about 50% of the butter product.

15. The butter product of claim 10, wherein the first butter is from 30% to 40% of the butter product.

16. The butter product of claim 10, wherein the first butter is from 60% to 70% of the butter product.

17. A butter product comprising: a first butter having a white or whitish color and a second butter having a brown color, wherein the first butter and the second butter are in a marbled pattern with areas of white or whitish color and areas of brown color.

18. The butter product of claim 17, wherein the second butter is from about 30% to about 50% of the butter product.
